(19) United States
(12) Patent Application Publication
(10) Pub. No.: US 2005/0094167 A1
(43) Pub. Date: May 5, 2005

(54) Method and apparatus of operating a printer

(75) Inventors: Ramon Vega, Barcelona (ES); Gonzalo Gaston, Barcelona (ES); Jose Luis Valero, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/697,010

(22) Filed: Oct. 31, 2003

(51) Int. Cl. G06F 15/00

(52) U.S. Cl. 358/1.8; 358/486

(57) ABSTRACT

An incremental printer comprising a plurality of printing elements grouped into redundant groups, each group being arranged to print substantially different portions of a given page of a printjob, the printer being adapted, when commencing a printjob, to control at least one redundant group of printing elements such that only a subset of the printing elements in that group are used to print, the printer being further arranged to subsequently increase the number of printing elements in that group which are used to print.

### CROSS REFERENCE TO RELATED APPLICATIONS

This application is related to the following patent application: U.S. patent application Ser. No. ______ filed Oct. 31, 2003, also entitled “Method and Apparatus for Operating a Printer”, in the name of Hewlett-Packard (Attorney Docket No. 200209836-1)

### FIELD OF THE INVENTION

This invention relates to printers. In particular, but not exclusively, it relates a to method of operating a printer of the kind comprising an array of dot printing elements extending in a first direction relative to a page to be printed and which prints at least a part of the page during relative movement between the printhead and page in a second direction substantially normal to the first direction. The invention is particularly, but not exclusively, suitable for the type of printers known as inkjet printers.

### BACKGROUND OF THE INVENTION

Inkjet printers print dots (pixels) by ejecting very small drops of ink onto a print medium (herein generically referred to as “paper”). Often they include a movable carriage that supports one or more printheads each having ink ejecting nozzles. The carriage repeatedly passes over the surface of the paper, which is moved incrementally relative to the carriage between passes, and the nozzles are selectively “fired” to eject drops of ink at appropriate times pursuant to commands of a microcomputer or other print controller, the timing of the application of the ink drops corresponding to the pattern of pixels of the image being printed.

There are also so-called page-high (or page-wide, depending on the page orientation) inkjet printers in which a printbar extends the full height (or width) of a page to be printed and has an array of ink ejecting nozzles along substantially its full length, so that an entire page is printed during a single pass of the printbar relative to the page. Again, a print controller determines which nozzles fire and when as the printbar passes over the page. In some cases the printbar moves across the stationary paper; in others, the printbar is stationary and the paper passes below it. These printers are especially useful for the fast printing of monochrome (e.g. black) text, and are used in, for example, monochrome copiers. Other inkjet printers use a printbar which, although not extending the full height or width of a page, extend a substantial part thereof, so that a complete page is printed only after a small number of passes, say two or three.

In inkjet printers with a large number of nozzles, such as page-wide and other printbar printers, after a prolonged period of inactivity it is necessary to eject a number of drops per nozzle, typically several hundred firing cycles, in order to “wake up” the nozzle before starting a print job. This results in a lot of ink wastage compared to the ink used to actually print.

FIG. 1 is a graph showing the transition of a nozzle from a non-working state to a fully operational state as a function of the number of firing cycles. On the left of FIG. 1 the absence of an ink dot produced by a non-working nozzle is shown as an open circle, a good ink dot produced by a fully operational nozzle is shown as a black-filled circle, and the ink dots produced by nozzles in an intermediate state are shown as circles with various types of fill as shown.

On order to avoid the waste of ink involved in servicing the nozzles prior to a print job, and thus reduce the overall cost of the print job, an alternative is to allow the nozzles to “wake up” during the print job itself. If a single row of dots were printed by a single nozzle this would be acceptable in many cases. Thus, as shown in FIG. 2(a), and assuming printing from left to right, the nozzle would rapidly become fully operational and only the extreme left hand edge of the print would suffer (it will be understood that FIG. 2 shows a simplified case where it is assumed that only five firings are needed to bring a nozzle into full operation; in fact, it can take up to 500 firings).

However, as is well known, nozzles are usually used in redundant groups to minimise artefacts in the printed image, and typically a group of four nozzles will be used to print the row of dots, different nozzles being used at different times to print consecutive dots in the row. This is shown in FIG. 2(b) where the nozzles in the redundant group are labelled 1 to 4. Here it can be seen that it takes much longer for all the nozzles to become fully operational, and the print quality would suffer for a greater distance into the printed image. Actually, the nozzles in a redundant group are not normally exactly aligned in the direction parallel to the direction of printing, but since the ink dots they produce have a diameter substantially greater than the spread of the nozzles in the direction normal to the printing direction, for all practical purposes they can be considered to print along the same row.

FIG. 2 assumes for simplicity that the row of printed dots is continuous along the line, as would occur for example in a region of area fill, but in general there will not be a printed dot at each consecutive dot location along the row, so the problem will be exacerbated.

### SUMMARY OF THE INVENTION

According to one aspect, the present invention provides a method of operating a printer of the kind comprising an array of dot printing elements extending in a first direction relative to a page to be printed and which prints at least a part of the page during relative movement between the array and the page in a second direction at an angle to the first direction, the array comprising a plurality of groups of elements with redundancy among the elements of the group, the method comprising, in respect of at least one of said groups, initially commencing printing using a subset of the elements in the group and, during the course of printing, increasing the number of elements available to print in the group.

In a first embodiment the number of elements in the group available to print is increased as a function of the distance travelled by the array. Alternatively, the number of elements in the group available to print may be increased as a function of the number of firing pulses sent to the elements of the group. In any case, it is preferred that each element newly made available to the group is initially made available for use less frequently than the existing element(s).

In one embodiment at least one element in the group is serviced prior to printing so that it is at least partially operational at the commencement of the print job, printing being commenced using the said at least one serviced element and one non-serviced element, the non-serviced element initially being made available for use less frequently than the said at least one serviced element.

The invention also provides a printer adapted to operate according to the method claimed in any preceding claim.

Although primarily applicable to inkjet printers, the invention is applicable to any printer where individual printing elements need to be brought into a serviceable condition prior to use in a print job.

### BRIEF DESCRIPTION OF THE DRAWINGS

Preferred embodiments of the invention will now be described, by way of example, with reference to the accompanying drawings, in which:

FIG. 1, previously described, is a graph showing the transition of a nozzle from a non-working state to a fully operational state as a function of the number of firing cycles.

FIGS. 2(a) and (b), previously described, are schematic diagrams which illustrate an example of the problem addressed by embodiments of the present invention.

FIG. 3 is a schematic diagram illustrating the operation of an embodiment of the invention.

FIG. 4 illustrates a page-high inkjet printer according to an embodiment of the invention.

FIG. 5 is a block diagram of a print control circuit for the printer of FIG. 4 which implements an embodiment of the invention.

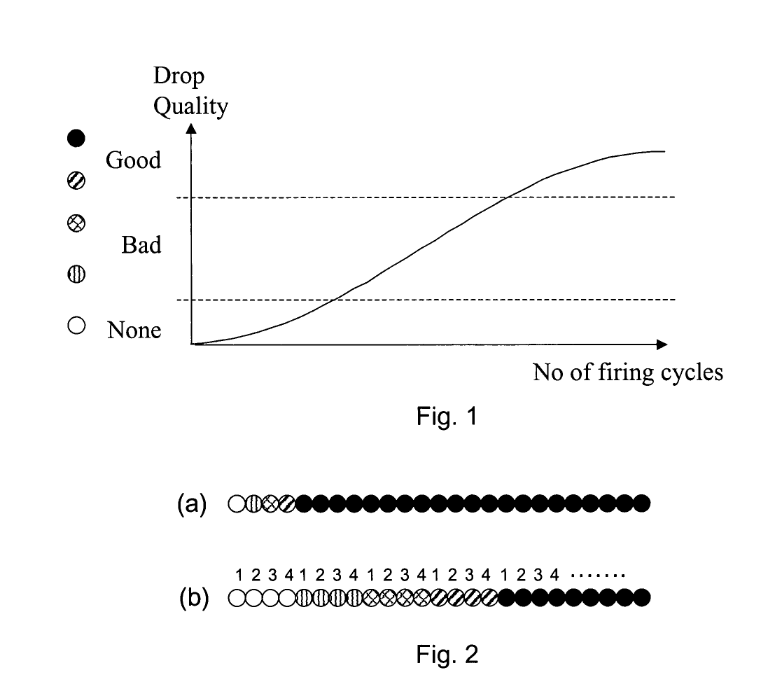

### DETAILED DESCRIPTION OF AN EMBODIMENT OF THE INVENTION

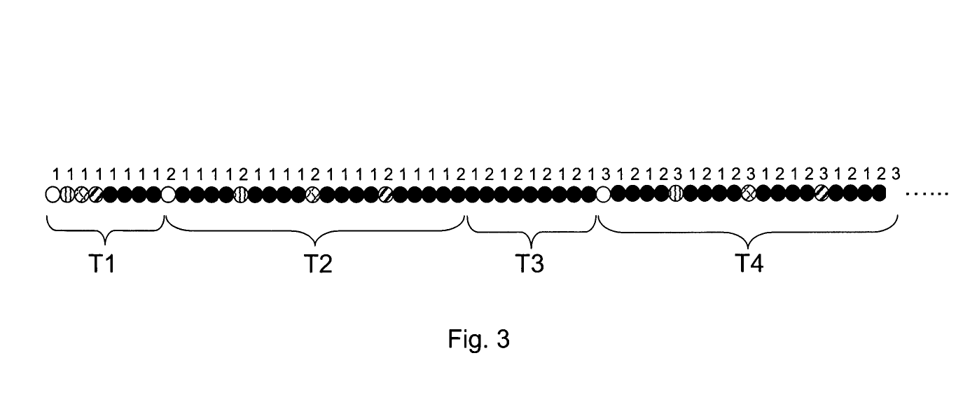

FIG. 3 again shows a row of consecutive dots printed by a redundant group of four nozzles labelled 1 to 4. In this case, however, at the start of the print job initially only the first nozzle 1 is used for a period of time T1. The period T1 is selected such that at the end of the period T1 the nozzle 1 will be fully operational. Next, during the period T2, the nozzle 2 is made available for use in the group, but only at a frequency less than that of the nozzle 1. In FIG. 3 the nozzle 2 is shown in use at one quarter the frequency of the nozzle 1. The period T2 is selected such that at the end of the period T2 the nozzle 2 will be fully operational. Next, for a period T3 the nozzles 1 and 2 are used with equal frequency.

Now, during the period T4 the nozzle 3 is made available for use in the group, but again at a frequency less that that of the existing nozzles 1 and 2, and the period T4 is selected such that at the end of the period T4 the nozzle 3 will be fully operational. This scheme continues so that after period T4 there will be a period T5 (not shown) where all three nozzles 1 to 3 are used with equal frequency followed by a period T6 (also not shown) during which the nozzle 4 is made available for use in the group, but at a frequency less that that of the existing nozzles 1 to 3. The period T6 is selected such that at the end of the period T6 the nozzle 4 will be fully operational. After the period T6 all nozzles are used with equal frequency. The periods T1 to T6 are preferably not absolute time periods but correspond each to a respective predetermined number of dot locations traversed by the group of nozzles. Of course, in the limit, the invention is applicable to arrangements using only two nozzles per redundant group, so that periods T3 onwards may not apply.

The foregoing assumes that dots are printed at all consecutive dot locations, so that at the end of the periods T1, T2, T4 and T6 the nozzles 1, 2, 3 and 4 respectively will have become fully operational. However, in general the image to be printed will not consist of rows of consecutive dots, so that it cannot be guaranteed for any particular redundant group of four nozzles that the nozzles will have become fully operational at the end of the relevant periods (where dots are not printed at all possible dot locations the nozzle identification numbers in FIG. 3 identify the nozzle which is allocated for use at that dot location, not that it necessarily prints there). For this reason the period T1 is made longer than that which would be necessary if all consecutive dots locations were printed, so that one can be reasonably sure, for a print job of average print density, that the nozzle 1 has become fully operational or nearly so at the end of the period T1. The periods T3 and T5 are introduced for the same reason—to allow the nozzles 2 and 3 respectively to become fully operational or nearly so in the case of an average print job before the introduction of the next nozzle.

It will be appreciated that in the scheme described above any defects arising from the non-working nozzles 2, 3 and 4 when they are first made available in the group are relatively hidden within the print due to their initial lower frequency of use.

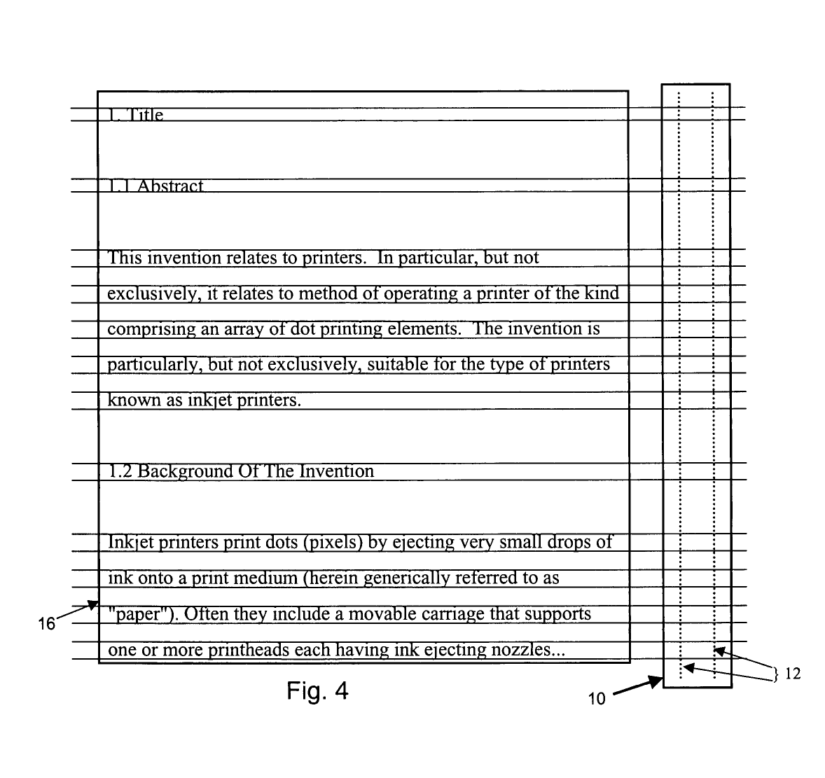

Referring now to FIG. 4, a monochrome text printer embodying the invention comprises a printbar 10 having an array 12 of inkjet nozzles, the array extending along the printbar for substantially the full height of a page 16 of paper to be printed. In this embodiment the printbar 10 passes from right to left (as seen in FIG. 4) across the width of the page 16 and all the text is printed in a single pass of the printbar. In FIG. 4 the position of the printbar is shown after the page has been printed. To print a subsequent page the printbar is returned to the left hand side of the page. The mechanical construction of such printers, and the print control circuits which coordinate the movement of the printbar and/or paper with the timed firing of the nozzles, is well known to those skilled in the art. In this embodiment the nozzles in the array 12 are notionally divided into groups of four nozzles each for printing a respective row of dots across the width of the page 16 with redundancy among the nozzles of each group.

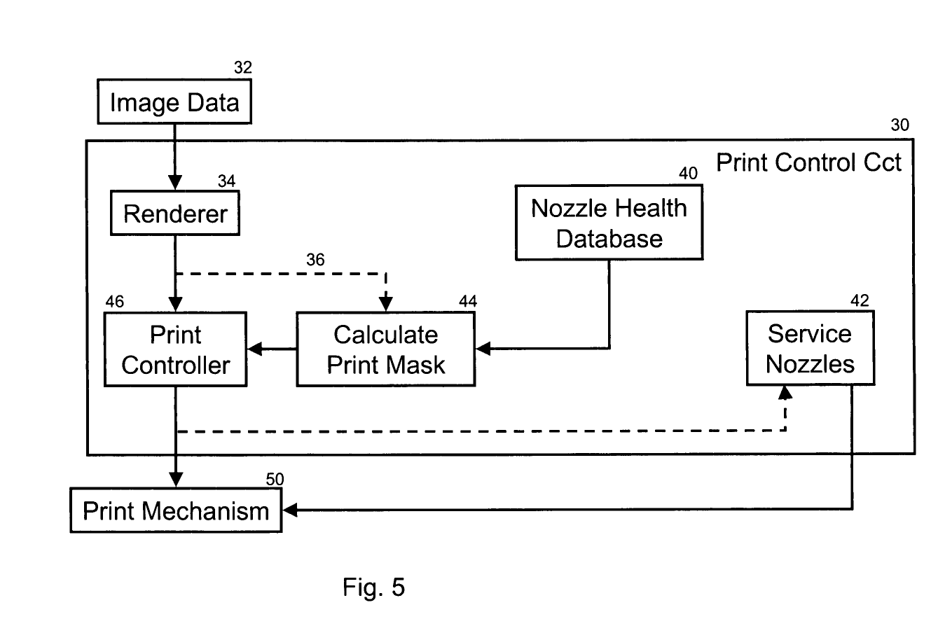

FIG. 5 is a schematic block diagram of a print control circuit 30 for the page-high monochrome inkjet text printer of FIG. 4 and which implements the principle described with respect to FIG. 3. The circuit will be described in functional terms, but will be understood that although various functional blocks are shown as separate modules in FIG. 5, in practice these functions are implemented by a suitably programmed microprocessor and associated memory. The control circuit 30 controls and coordinates the operation of the mechanical and electrical components of the printer, that is to say, the paper feed mechanism, the printbar drive mechanism and the inkjet nozzle firing circuitry, all of which may be of conventional construction and are designated in FIG. 3 by the generic term “print mechanism” 50.

Image data 32 is received in a standard format such as Postscript, PCL, HPGL by the print control circuit 30 from a computer, scanner or other external device. The data is processed by a renderer 34 to covert the image data to halftone data.

Meanwhile, block 44, the print mask of the image to be printed on the page 16 is calculated. The concept of a print mask is well-known. It is an image-independent matrix which determines which inkjet nozzle should be used at each potential dot location on the page. It doesn't determine whether a dot is actually to be printed at any given location, merely the nozzle which will be used if a dot is to be printed. In the present case the print mask implements the technique described with reference to FIG. 3, i.e. nozzles are progressively made available for use in each group as a function of the number of dot locations traversed by the array as the printing progresses. If desired, the periods T1-T6, as defined by the print mask, may be varied according to the print density of the image (dashed line 36). The print mask may also be modified according to the contents of a nozzle health database 40 which identifies certain nozzles as faulty in which case those nozzles are excluded from being made available for use within a group. The concept of a nozzle health database is well-known in the art and identifies nozzles that, despite servicing, misfire or do not fire. The database 40 is built up by scanning test patterns according to the principles described, for example, in our copending U.S. patent application Ser. No. ______ (HP 60015794-1). Although the latter relates to incremental printers, the same principles can be used for page-wide and page-high printers.

Having established the print mask, whether or not a dot is actually to be printed at any given dot printing location is determined by the halftone image data from the renderer 34, the image data being combined with the print mask in a print controller 46 which calculates the nozzle firing pattern for that image. Essentially, the nozzle firing pattern is a binary pattern that determines exactly which inkjet nozzles are fired at which instants during relative movement of the printbar over the page 16 and, if the print job is more than one page, subsequent pages. The print controller 46 also controls the print mechanism 50 to print the page according to the firing pattern thus calculated.

If desired, block 42, the print control circuit 30 may instruct the print mechanism 50 to service one nozzle in each group prior to commencing the print job, that is to say, firing the nozzle a sufficient number of times to render it fully operational. Then, the print mask can omit the period T1 and start at the beginning of the period T2. Alternatively, the print control circuit 30 may instruct the print mechanism 50 to service one nozzle so that it is only partially operational at the commencement of the print job—in this case the period T1 would be reduced but not eliminated.

Another possibility within the scope of the invention is to service more than one nozzle, partially or fully, prior to the print job. Then, printing would begin using the serviced nozzles and further nozzles brought progressively into use. Then again, even without prior servicing of nozzles(s), it is possible to shorten the periods T1, T2, etc. so that nozzle 2 is brought into use before the nozzle 1 has become fully operational, nozzle 3 is brought into use before nozzle 2 is fully operational, and so on, and periods such as T3 (where all the nozzles so far made available are fully operational for a while before a fresh nozzle is made available) are omitted.

In general, the number (if any) of nozzles to be serviced, partially or fully, before the print job, and the duration of the periods T1, T2, etc., can be chosen “intelligently” by the system depending on the print quality required and nozzle reliability.

The above method, i.e. “waking up” nozzles progressively from a non-operational state during printing, can also be used in respect of nozzles which, although they have already been used in a print job, have lain dormant for a while so that they have become at least partially non-operational and need to be woken up again during the same print job.

In embodiments where one or more nozzles are serviced prior to a print job, the present invention may be combined with that described in our copending application Ser. No. ______ Docket No. ID 200209836). In that case, prior to commencing printing, the print control circuit identifies portions of the array of printing elements which will be needed at least for a first pass of the array relative to the first page of the print job, and services printing elements according to the array portions so identified whereby one or more printing elements outside the identified array portions are not serviced. The same technique can be used in combination with the present invention.

Copending application Ser. No. ______ (Attorney Docket No. ID 200209836) also describes nozzles organised into redundant groups each for printing a row of halftone values rather than a single row of dots. The present invention may also be used in relation to such groups, a subset of the nozzles in each group being used initially and the number of nozzles used being increasing during printing.

Although the above embodiment makes nozzles newly available to each group as a function of the number of dot locations traversed by the array 12, i.e. as function of the distance travelled by the array, other criteria for the introduction of nozzles can be used. For example, the number of elements available in each group may be progressively increased as the existing element(s) of the group become fully operational, as determined by the number of times they have actually been fired. Alternatively, the operational status of the available elements in each group at each of a plurality of predetermined time instants could be determined, and an element is newly made available to the group if all the existing element(s) in the group are fully operational, again as determined by the number of times they have actually been fired, at a given time instant.

The above embodiment assumes that the printbar prints from left-to-right only, and that a full page is printed in a single pass of the printbar. However, the page could be printed bi-directionally, one half of the dots being printed during left-to-right movement of the print bar and the other half printed during right-to-left movement. Furthermore, the printbar need not extend the full height of the page, so that several passes are necessary to print the full page. For example, in a half-height printbar two passes will be necessary to print the full height of the page.

The invention is also not limited to monochrome printers which use only a single colour (usually black) of ink. In the case of colour printers where separate nozzle arrays are used for different colours, the above technique is applied to each array.

The invention is not limited to the embodiment described herein and may be modified or varied without departing from the scope of the invention.

1. A method of operating a printer of the kind comprising an array of dot printing elements extending in a first direction relative to a page to be printed and which prints at least a part of the page during relative movement between the array and the page in a second direction at an angle to the first direction, the array comprising a plurality of groups of elements with redundancy among the elements of the group, the method comprising, in respect of at least one of said groups, initially commencing printing using a subset of the elements in the group and, during the course of printing, increasing the number of elements available to print in the group.

2. The method claimed in claim 1, wherein each redundant group is arranged to print a respective row of dots in the second direction.

3. The method claimed in claim 1, wherein the number of elements in the group available to print is increased as a function of the distance travelled by the array.

4. The method claimed in claim 1, wherein the number of elements in the group available to print is increased as a function of the number of firing pulses sent to the elements of the group.

5. The method claimed in claim 1, wherein each element newly made available to the group is initially made available for use less frequently than the existing element(s).

6. The method claimed in claim 1, wherein at least one element in the group is serviced prior to printing so that it is at least partially operational at the commencement of the print job, printing being commenced using the said at least one serviced element and one non-serviced element, the non-serviced element initially being made available for use less frequently than the said at least one serviced element.

7. The method claimed in claim 6, comprising, prior to commencing printing, identifying portions of the array of printing elements which will be needed at least for a first pass of the array relative to the first page of the print job, and servicing printing elements according to the array portions so identified whereby one or more printing elements outside the identified array portions are not serviced.

8. The method claimed in claim 1, wherein faulty printing elements, as identified by a faulty printing element database, are excluded from being made available to the group.

9. The method claimed in claim 1, wherein the array of printing elements extends substantially fully across the page in the first direction.

10. The method claimed in claim 1, wherein the printer is an inkjet printer and the dot printing elements are inkjet nozzles.

11. An incremental printer comprising a plurality of printing elements grouped into redundant groups, each group being arranged to print substantially different portions of a given page of a printjob, the printer being adapted, when commencing a printjob, to control at least one redundant group of printing elements such that only a subset of the printing elements in that group are used to print, the printer being further arranged to subsequently increase the number of printing elements in that group which are used to print.

12. An incremental printer according to claim 11, wherein each redundant group is arranged to print a row or column of image data.

13. An incremental printer according to claim 12, wherein the elements are arranged to move relative to the image being printed and the number of elements in the subset of that group is increased in dependence upon the degree of movement between the elements and the image being printed.

14. An incremental printer according to claim 12, wherein the number of elements in the subset of that group is increased in dependence upon the cumulative number of firing pulses sent to the elements of the group during the printing of the printjob.

15. An incremental printer according to claim 11, the printer being further arranged, when increasing the number of printing elements in subset of that group, to cause the one or more printing elements newly included in the subset to print for a predetermined duration at a frequency lower than that of one or more printing elements previously included in the subset.

16. An incremental printer according to claim 11, wherein at least one element in that group is serviced prior to commencing the printjob.

17. An incremental printer according to claim 11, wherein the plurality of printing elements form a page wide or a page high array.

18. An incremental printer according to claim 11, wherein the printer is an inkjet printer and the printing elements are inkjet nozzles.

19. A printer control circuit adapted to control a printer to perform the method claimed in claim 1.

20. A computer readable medium containing program instruction which, when executed by a data processing device, control a printer to perform the method claimed in claim 1.
